(19) United States
(12) Patent Application Publication
(10) Pub. No.: US 2011/0143263 A1
(43) Pub. Date: Jun. 16, 2011

(54) Catalyst Layer Having Thin Film Nanowire Catalyst and Electrode Assembly Employing the Same

(75) Inventor: Alireza Pezhman Shirvanian, Ann Arbor, MI (US)

(73) Assignee: FORD GLOBAL TECHNOLOGIES, LLC, Dearborn, MI (US)

(21) Appl. No.: 12/770,084

(22) Filed: Apr. 29, 2010

(51) Int. Cl. H01M 4/02; B01J 23/00; B01J 23/38; B01J 23/42; B01J 23/755

(52) U.S. Cl. 429/523; 502/100; 502/325; 502/326

(57) ABSTRACT

According to at least one aspect of the present invention, a fuel cell catalyst layer is provided. In one embodiment, the fuel cell catalyst layer includes first spaced apart strands extending longitudinally in a first direction, second spaced apart strands extending longitudinally in a second direction, the first and second spaced apart strands collectively defining openings bounded by an adjacent pair of the first spaced apart strands and an adjacent pair of the second spaced apart strands, a number of wires extending longitudinally in a third direction from one of the first and second spaced apart strands, and a catalyst contacting at least a portion of the plurality of wires.

### BACKGROUND

1. Technical Field

One or more embodiments of this invention relate to a catalyst layer having thin film nanowire catalyst (TFNW) and an electrode assembly employing the same.

2. Background Art

While reliability and working lifetime have been considered for utilizing fuel cell (FC) technologies in automotive applications, catalyst activity remains one factor that needs thorough consideration for commercializing fuel cell technologies and in particular fuel cell vehicles. Efforts have been made with a focus on developing fuel cell catalysts having a desirable electro-catalytic oxygen reduction reaction (ORR). To this end, fuel cell catalysts configured as what is known as the core-shell nano-particles, show some improvement over pure platinum nano-particles and/or pure platinum alloys nano-particles supported on carbon. However, these conventional core-shell catalysts, by virtue of being nano-particles, are still prone to agglomeration, dissolution and other durability issues.

### SUMMARY

According to at least one aspect of the present invention, a fuel cell catalyst layer is provided. In one embodiment, the fuel cell catalyst layer includes first spaced apart strands extending longitudinally in a first direction, second spaced apart strands extending longitudinally in a second direction, the first and second spaced apart strands collectively defining openings bounded by an adjacent pair of the first spaced apart strands and an adjacent pair of the second spaced apart strands, a number of wires formed on at least one of the first and second spaced apart strands, and a catalyst contacting at least a portion of the number of wires.

In another embodiment, the openings are provided with an average planar linear dimension of 10 to 70 micrometers. In yet another embodiment, the openings are configured to contain a reagent selected from the group consisting of an ionomer, porous carbon, Teflon® and combinations thereof to assist with water management and proton/electron and reactant transport.

In yet another embodiment, the wires extend radially from a surface of at least one of the first and second spaced apart strands.

In yet another embodiment, the fuel cell catalyst further includes an intermediate material positioned between the metallic catalyst and the portion of the wires to effect a function selected from the group consisting of promoting the formation of the metallic catalyst on the wires, enhancing electronic and/or lattice interactions of the metallic catalyst with the wires, and combinations thereof.

According to another aspect of the present invention, a fuel cell electrode assembly is provided. In one embodiment, the fuel cell membrane electrode assembly (MEA) includes a proton exchange membrane and a catalyst layer described herein, the catalyst layer being disposed next to the proton exchange membrane.

### BRIEF DESCRIPTION OF THE DRAWINGS

FIG. 1 depicts a perspective view of a fuel cell electrode assembly according to one embodiment of the present invention;

FIG. 2A depicts an enlarged view of a catalyst layer for use in the fuel cell electrode assembly of FIG. 1;

FIG. 2B depicts an enlarged view of a portion of the catalyst layer of FIG. 2A, the portion containing a plurality of wires extending from a surface of the portion;

FIG. 3A depicts an enlarged view (1,250×) of a plurality of wires according to one or more examples described herein;

FIG. 3B depicts an enlarged view (5,000×) of wires of according to one or more examples described herein;

FIG. 3C depicts an enlarged view (10,000×) of wires according to one or more examples described herein;

FIG. 3D depicts an enlarged view (20,000×) of wires according to one or more examples described herein;

FIG. 3E depicts an enlarged view (50,000) of wires according to certain examples described herein;

FIGS. 4A-4B schematically depict process steps for forming the wires of FIG. 2B according to yet another embodiment of the present invention;

FIG. 4C schematically depicts one of the wires of FIG. 2B;

FIGS. 5A-5D schematically depict process steps for forming the wires of FIG. 2B according to yet another embodiment of the present invention; and

FIGS. 6A1-6A2, 6B1-6B2, 6D and 6E1-6E2 depict processes for generating wires on a mesh substrate according to one or more embodiments of the present invention.

### DETAILED DESCRIPTION

As required, detailed embodiments of the present invention are disclosed herein. However, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or a representative basis for teaching one skilled in the art to variously employ the present invention.

Moreover, except where otherwise expressly indicated, all numerical quantities in the description and in the claims are to be understood as modified by the word “about” in describing the broader scope of this invention. Also, unless expressly stated to the contrary, the description of a group or class of material as suitable or preferred for a given purpose in connection with the invention implies that mixtures of any two or more members of the group or class may be equally suitable or preferred.

Fuel cells have been pursued as a source of power for transportation because of their high energy efficiency and their potential for fuel flexibility. However, broad commercialization of the fuel cells has been met with many limitations, particularly in relation to the relatively high cost of the fuel cell catalyst. Some of catalyst metals as used in fuel cell applications include noble and transition metals, such as platinum, which are very expensive. An amount of about 0.5 to 4 milligrams per square centimeter precious metals such as platinum is often required for a conventional fuel cell catalyst. It has been estimated that the total cost of the noble metal catalysts is approximately 75 percent (%) of the total cost of manufacturing a low-temperature fuel cell stack.

One source of the high cost of conventional fuel cell catalyst may be due to the insufficient use of the catalyst itself. By way of example, conventional fuel cells employ catalyst in the form of nano-particles supported on porous carbon support. The nano-particles are about 2 to 20 nanometers in diameter, are intrinsically less active than their bulk counterparts. These conventional platinum nano-particles are often provided with several hundred or more atoms and atomic layers of catalyst metals; however, only a few surface atomic layers of the nano-particles are accessible to fuel cell reactants and remain active for electrochemical reaction, while majority of the catalyst layers toward the center of the nano-particle remain essentially inactive. In addition, due to their inherently high surface energy, nano-particles tend to aggregate to form larger particles, and may actually dissolve into the electrolyte membrane and consequently lose surface area and catalytic activities.

Another limitation associated with certain conventional fuel cell system is ineffective flooding control. By way of example, certain reactants including oxygen/hydrogen gas, water, and protons cannot easily move across the catalyst sheet and as a result, little or no electrochemical reaction happens. Moreover, even if some oxygen gas, hydrogen gas, and proton do move across the catalyst sheet, resultant water molecules cannot move across the catalyst sheet and therefore often results in water flooding.

One or more embodiments of the present invention, as will be described in more detail below, alleviate some of the above-identified issues associated with the conventional fuel cell systems.

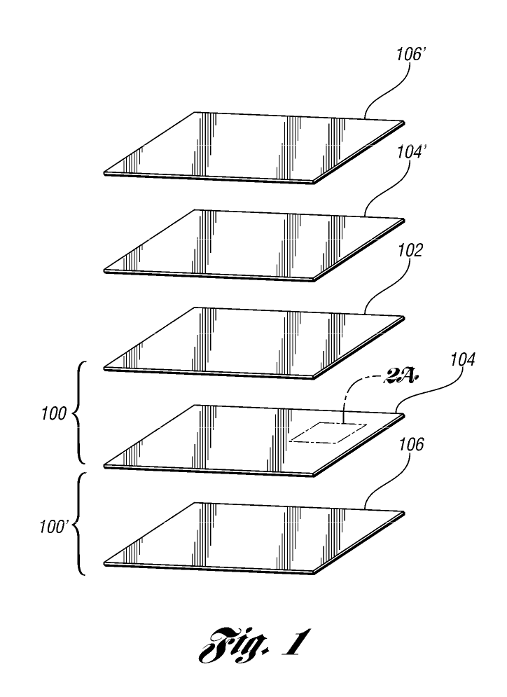

According to one aspect of the present invention, a fuel cell electrode assembly is provided. In one embodiment, and as depicted in FIG. 1, the fuel cell electrode assembly can be configured for use as a catalyst coated membrane 100 including a proton exchange membrane 102 and a catalyst layer 104. Alternatively, the fuel cell electrode assembly can be used as a gas diffusion electrode 100′ including a gas diffusion layer 106 and the catalyst layer 104. It is noted that the electrode assembly 100, 100′ is equally applicable to the other side of the proton exchange membrane 102, for instance to include a catalyst layer 104′ and a gas diffusion layer 106′ for use as a balance electrode.

The PEM 102 may be made of any suitable polymer electrolyte or its derivatives. The polymer electrolytes useful in the present invention illustratively include copolymers of tetrafluoroethylene and one or more fluorinated, acid-functional comonomers. Typical polymer electrolytes include Nafion® (DuPont Chemicals, Wilmington Del.) and Flemion™ (Asahi Glass Co. Ltd., Tokyo, Japan). While Nafion® is a common PEM, the usefulness of this invention is not limited by a particular choice of Nafion or any other solid electrolyte. In fact, liquid electrolytes and solid electrolytes are both amenable to one or more embodiments of the present invention.

FIG. 2A depicts an enlarged view of a portion of the catalyst layer 104, including first spaced apart strands 202 extending longitudinally in a first direction AA′ and second spaced apart strands 204 extending longitudinally in a second direction BB', forming an interconnected network defining a number of openings 206. FIG. 2B depicts an enlarged view of a section “aa” of the interconnected network 200 of FIG. 2A, showing secondary structures, for instance, a plurality of wires 210 extending longitudinally from a surface 212 of the strand 202 in a third direction CC'. In certain instances, the wires 210 extend radially from the surface 212 as shown in FIG. 2B. The catalyst layer 104 further includes a catalyst 208 in overlaying contact with at least a portion of the first and second spaced apart strands 202, 204. In certain particular instances, the catalyst 208 is configured as a continuum film.

In one or more embodiments, the term “continuum” or “thin film” refers to a continuous extent, succession, or whole, no part of which can be distinguished from neighboring parts except by arbitrary division. Unlike the atoms contained within the conventional platinum nano-particles, the catalyst atoms contained within the continuum film as supported on the interconnected network, according to one or more embodiments of the present invention, together form a continuum as they have attained their desirable coordination number and relatively low surface energies; and they are not segregated from each other and therefore more resistant to catalyst dissolution. U.S. patent application titled “Catalyst Layers Having Thin Film Mesh Catalyst (TFMC) Supported on a Mesh Substrate and Methods of Making the Same” with file ID of FMC2607PUSP (81186466) and Ser. No. 12/495,839, and U.S. patent application titled “Fuel Cell Electrode Assembly and Method of Making the Same” with file ID of FMC2934PUS (81205395) and Ser. No. ______ (to be provided), filed on Apr. 29, 2010 together provide a detailed description of the “continuum” or “thin film” atomic layers of catalyst metals, the entire contents thereof are incorporated herein by reference.

Unlike conventional carbon-supported fuel cell catalyst wherein catalyst metals are present in discrete nano-particles wherein electronic connection between the discrete particles is provided through the carbon support material, the catalyst metal atoms of the metallic catalyst 208 having catalyst atoms presented in a continuum film according to one or more embodiments of the present invention are substantially connected to each other electronically without the need for an intermediate connecting medium such as carbon.

In yet another embodiment, wires or nanowires 210 can be grown on both planar sides of the interconnected network 200 to provide additional catalytic surface area.

In yet another embodiment, two or more planar layers of the interconnected network 200 can be aligned next to each other to provide additional catalytic surface area.

In yet another embodiment, the catalyst layer 104 does not need a stand alone interconnected network 200 for support and instead can be directly supported on the substrate 102, 106, or 106′. In this arrangement, an interconnected network or mesh 200 described herein can be used to imprint or emboss the substrate for form a corresponding impression on the substrate. The interconnected network 200 can then be removed. The catalyst 208 can be deposited directly onto the impression area of the substrate. The interconnected network 200 can be made of any materials and for economical efficiency is made of relatively cheap metals such as copper, nickel, or iron. In addition, the interconnected network 200 can be provided to have the wires 210 extending therefrom and the resultant structure can be used to imprint or emboss the substrate.

In one or more embodiments, the term “wires” or “nanowires” are used interchangeably. The term “nanowire” does not necessarily indicate the wires are of dimensions in nanometer scale. The wires or the nanowires may have an average diameter in nanometer scale and/or an average length in micrometer scale.

In one or more embodiments, the mesh substrate, metallic, non-metallic, or combinations thereof, preferably metallic, forms the support upon which the catalyst continuum film is in overlaying contact. The mesh substrate can be further designed to provide high catalytic surface area for fuel cell electrochemical reactions, thereby maximizing the triple phase boundaries among the catalyst, the ionomer, and the gases. The mesh substrate support allows facile passage of protons/water and gases through the openings provided therein, while transfer of electrons to and from the reaction site may take place rapidly through the continuous conductive thin film of catalyst or mesh substrate.

In yet another embodiment, the openings 206 are configured to have an average planar linear dimension of 10 to 70 micrometers, wherein the planar linear dimension is the largest linear distance between any two points on the perimeter of each of the openings 206. Without being limited to any particular theory, it is believed that the openings thus sized further improves water management by limiting water accumulation in and around the affected openings 206 and thereby reducing the propagation of the flooding into neighboring openings 206.

In yet another embodiment, the openings 206 are further configured to be filled with a reagent selected from the group consisting of an ionomer, porous carbon, Teflon® and combinations thereof to assist with water management and transport of protons, electrons, and/or other fuel cell reactants.

In yet another embodiment, the fuel cell catalyst layer 104 further includes an intermediate material (not shown) contacting at least a portion of the first spaced apart strands 202, the second spaced apart strands 204, and the wires 210, wherein the catalyst 208 is formed on the intermediate material and directed away from the first and second spaced apart strands and the wires. The intermediate material can be a polymer to promote the proper atomic orientation of the catalyst 208. In certain instances, the polymer is in lattice communication with the catalyst 208.

The intermediate material can be in electronic communication with the catalyst 208 for fine tuning catalytic activity and enhancing electronic interactions with the first spaced apart strands 202, the second spaced apart strands 204, and/or the wires 210. Non-limiting examples of the electronic conducting intermediate material may include magnesium oxide, zirconium oxide, niobium oxide, molybdenum oxide, or combinations thereof. Non-limiting examples of the polymers include polyamides such as Kapton from Dupont, polyesters, and polyaramids. Non-limiting examples of the intermediate material may include magnesium, zirconium, niobium, molybdenum, aluminum, cobalt, copper, nickel, tantalum, tungsten, iron, titanium, their oxides, or combinations thereof. Non-limiting examples of the intermediate material may also include semi-conductors such as germanium, silicon, or their oxides; and organic materials such as polynuclear aromatic hydrocarbons, heterocyclic aromatic compounds. Chapters 30 and 31 of “Organic Chemistry” by Morrison and Boyd, 3^{rd} edition, Allyne and Bycon, 1974, provide a good description of the heterocyclic aromatic compounds, the entire contents thereof are incorporated herein by reference.

Unlike conventional fuel cell catalyst which is either supported on carbon particles embedded in a gas diffusion layer or supported on an electrolyte membrane, the catalyst 208 according to one or more embodiments of the present invention can be introduced into the fuel cell compartment as a separate layer supported on a mesh substrate as an interconnected network having thereupon catalyst-containing nanowires.

The openings 206 are provided for passing certain fuel cell reactants. As used herein, the term “fuel cell reactants” refer to gases and liquids ordinarily involved in a fuel cell electrochemical reaction. Fuel cell reactants include many species depending upon the fuel cell type. Examples of the hydrogen fuel cell reactants include oxygen gas, hydrogen gas, oxygen ions, hydrogen ions, and water molecules. The openings 206 may take any suitable geometric shapes. Examples of the shapes include cones and pyramids.

In yet another embodiment, the openings 206 may be filled with ionomers to provide additional protonic or ionic connectivity, to assist proton transfer or can be left empty for gases to diffuse down to reach the membrane. When the openings are filled with ionomers, ionic charge carriers or protons can be carried out to the GDL side of the catalyst layer (the mesh layer) where the electrochemical reaction takes place. If the openings are not filled with ionomers, the reactant gases must instead travel down towards the membrane adjacent to the catalyst layer to meet with ionic charge carriers or protons for reaction.

In yet another embodiment, the openings 206 may be filled with a mixture of ionomer and porous carbon to provide additional ionic and electronic conductivity and to assist with water management and reactant transport.

Whether the openings 206 should be filled with ionomers is a matter of design. If the openings 206 are filled with ionomer, the ionic charge carriers and/or protons may be carried out to the catalyst layer adjacent to GDL layer where the electrochemical reaction can happen. This design may be appropriate if the interconnected network or mesh 200 is relatively thick wherein the presence of ionomers can offset the relatively longer passage the ionic charge carriers and/or protons are to travel from one side of the interconnected network or mesh 200 to the other. This design may also be more appropriate for low temperature fuel cells where the product water can form droplets that can be removed through GDL. If the openings are not filled with ionomer, the reactive gases must diffuse down the hole to reach the ionic charge carrier- and/or proton-rich membrane in order for the reaction to happen.

In yet another embodiment, the interconnected network 200 is provided with a porosity of from 25 to 75 percent, or more particularly from 35 to 65 percent. As used herein, the term “porosity” refers to a fraction of the void spaces defined by the one or more openings in the catalyst layer. Within this regard, the porosity is a function of size, shape and numbers of openings and grids, and thickness of the mesh 200. As a combination parameter, the porosity may be adjusted to accommodate a particular catalyst loading requirement suitable for certain applications. In addition, when the mesh 200 is relatively thick, an effective catalytic active area of the catalyst layer may be further increased by growing or depositing catalyst on the inside walls (e.g., perpendicular to the facile plane of the mesh 200) of the openings without having to necessarily increase or decrease the porosity of the catalyst layer 112.

The first and second spaced apart strands 202, 204, and/or the wires 210 can be made of any suitable materials, including gold, ceramics, nickel, steel, copper, iron, cobalt, chromium, plastics, polymers, and combinations thereof. The surface of the first and second spaced apart strands 202, 204, and/or the wires 210 can be provided with surface features to better accommodate catalyst film growth for the desired crystalline structure.

The catalyst 208 such as a platinum continuum film can be configured to have any suitable thickness for an intended design. In certain instances, the platinum continuum film can be formed of 1 to 20 and preferably 4 to 10 atomic layers. A total thickness of the platinum continuum film is in a range of 0.1 to 500 nanometers, 2 to 450 nanometers, 10 to 400 nanometers, or 25 to 350 nanometers. In general, the thinner is the mesh, the less is the cross resistance or the ohmic loss. However, it should be noted that the thickness of the mesh 200 does not restrict in any way the practice of the present invention. The thickness of the mesh 200 may be controlled to provide a desirable loading of the catalyst 208.

In yet another embodiment, the metallic catalyst 208 includes catalyst metals configured as single crystalline, polycrystalline, or combinations thereof. In the event that the single crystals of platinum are used, the single crystals of preference are characterized as having (110) and/or (111) facets. In certain particular instances, the single crystals are each provided in the thickness direction with 1 to 20 atomic layers and particularly 1 to 12 atomic layers, such that precious catalyst metals can be effectively used. Alternatively, in the event that the polycrystalline form of materials are used, the preferred polycrystalline for platinum or platinum containing alloys is characterized as having (111) facets and (100) tops. The performance of the (100) and (111) crystal surface of bulk catalyst metal such as platinum is far superior to conventional platinum nano-particles. Because the catalyst such as platinum can be grown in single crystals and configured as a thin continuum film on the mesh substrate having nanowires, this catalyst behaves more like the bulk metal catalyst with preferred crystalline structure and is provided with relatively higher catalytic activity per a given surface atom relative to the catalyst on surface atom in a conventional nano-particle configuration.

In yet another embodiment, the catalyst 208 include alloy Pt₃Ni with “Pt-Skin” and “Core-Shell” catalysts in a non-limiting “sandwich” type of configuration. The Pt-skin in the core-shell catalyst can be formed of Pt atoms arranged in atomic layers as described herein and behave more like metal atoms in bulk. Stamenkovic et al., titled “surface composition effects in electrocatalysis: kinetics of oxygen reduction on well-defined PtNi and PtCo alloy surfaces,” Journal of Physical Chemistry B; 2002, 106(46), 11970-11979, discloses the aforementioned concept of bulk metal catalyst, the entire contents thereof are incorporated herein by reference.

Stamenkovic et al., titled “Improved Oxygen Reduction Activity on Pt₃Ni(111) via Increased Surface Site Availability,” Science, vol. 315, 2007, the entire contents thereof being incorporated herein by reference, discloses that metal atoms in bulk such as Pt₃Ni(111) are approximately 90 times more active than platinum nano-particles on carbon with almost two orders of magnitude improvement. Pure bulk platinum is known to have almost 10 times more activity per catalyst surface area than the Pt nano-particles. Therefore, with the continuum or thin film configuration of the catalyst metals such as the Pt metal atoms arranged in the Pt-skin for the core-shell catalysts, the present invention in one or more embodiments enables the performance of catalyst metal more like metal atoms in bulk and therefore more active than the conventional Pt on carbon nano-particles. Conventional systems in utilizing Pt₃Ni catalyst in fuel cells are met with challenges of creating catalyst bulk having electronic and morphological properties similar to bulk Pt₃Ni(111). Given that the catalyst 208 can be configured as thin continuum film which is grown into well defined crystalline surfaces, the incorporation of bulk Pt₃Ni(111) to fuel cells can be realized and practiced with greater certainty.

One example of the core-shell substructures that can be employed in the metallic catalyst according to one or more embodiments of the present invention is illustratively shown in Zhang et al., titled “platinum monolayer on nonnble metal-metal core-shell nanoparticle electrocatalysts for O₂ reduction,” Journal of Physical Chemistry B, 2005, 109(48), 22701-22704, the entire contents thereof are incorporated herein by reference.

Deposition of catalyst atoms for forming the metallic catalyst 208 can be accomplished by sputtering using vapor deposition, atomic layer deposition, PVD, CVD, electro-deposition, and colloidal methods. Due to the relatively lower surface energy inherent within the continuum film of catalyst atoms, the resultant catalyst layer is provided with relatively higher stability and activity. Thus, the concept of bulk metal catalyst (“surface composition effects in electrocatalysis: kinetics of oxygen reduction on well-defined PtNi and PtCo alloy surfaces;” Stamenkovic et al., Journal of Physical Chemistry B; 2002, 106(46), 11970-11979) that is 5-10 times more active relative to catalyst of nano-particles can be effectively employed in the TFNW according to one or more embodiments of the present invention.

Deposition of catalyst atoms for forming the catalyst 208 can be accomplished by sputtering using vapor deposition, atomic layer deposition (ALD), PVD, CVD, electro-deposition, and colloidal methods. Due to the relatively lower surface energy inherent within the continuum film of catalyst atoms described herein according to one or more embodiments of the present invention, the resultant catalyst 208 is provided with relatively higher stability and activity. Thus, the concept of bulk metal catalyst such as the bulk metal construction of Stamenkovic et al. referenced herein can be effectively employed in the catalyst 208 according to one or more embodiments of the present invention.

The interconnected network 200 upon which the catalyst 208 is deposited can be mass produced using stamping/electrodepositon techniques for micro- or nano-fabrication. Exemplary stamping methods may be had according to Mirkin et al. “Emerging methods for Micro- and nanofabrication”, MRS bulletin, July 2001; and Walker et al. “Growth of thin platinum films on Cu (100): CAICISS, XPS and LEED studies”, Surface Science 584 (2005) 153-160. Nanofabrication methods, such as soft lithography have also been used to transfer a mesh pattern of openings to a metallic thin film of gold with thickness of 100 nanometers (nm). As such, the mesh substrate having nanowires can be used to support the continuum film of the metallic catalyst to form the fuel cell catalyst layers. Non-limiting nanofabrication methods are disclosed in “Patterned transfer of metallic thin film nanostructures by water-soluble polymer templates” authored by C. D. Schaper, Nano Lett., Vol. 3, No. 9, pp 1305-1309, 2003, the entire contents thereof are incorporated herein by reference.

Vacuum deposition techniques, preferably electron beam physical vapor deposition (EB-PVD) or RF sputtering, may be used to deposit, atom by atom, the catalyst metals for forming the catalyst 208. Any suitable stamping techniques for micro or nano-fabrication applications can be used to manufacture the mesh substrate support according to one or more embodiments of the present invention. For instance, micro- or nano-fabrication methods, such as soft lithography, can be used.

It is an advantage, and as described herein above, that catalyst dissolution common to conventional catalyst nano-particles can be effectively reduced through the implementation of continuum film of metallic catalyst, according to one or more embodiments of the present invention. Degradation due to particle dissolution may be removed since catalyst metals presented as a continuum film is intrinsically more stable than conventional catalyst nano-particles due to the lower surface energy associated with films. Moreover, catalyst agglomeration inherent in conventional carbon-supported catalyst nano-particles can be effectively reduced. Degradation due to particle agglomeration may be removed. The catalyst layer based on metallic thin film does not contain particles and the surface properties of thin films more resemble that of the bulk catalyst than nano-particles.

It is a further advantage, and according to one or more embodiments of the present invention, that carbon support for the catalyst layers can be reduced or eliminated. As a result, issues such as carbon support corrosion and large Ohmic losses for electron transfer through carbon support may be avoided since essentially no carbon is necessarily used to support the catalyst in TFNW concept. Furthermore, peroxide formation that degrades membranes is significantly reduced.

Having generally described this invention, a further understanding can be obtained by reference to certain specific examples which are provided herein for purposes of illustration only and are not intended to be limiting unless otherwise specified.

### EXAMPLES

### Example 1

### Forming the Wires Illustratively Shown at 210 in FIG. 2B

Several methods can be used to manufacture the wires as described herein. Among them are evaporation-condensation, vapor-liquid-solid (VLS) growth, and template based.

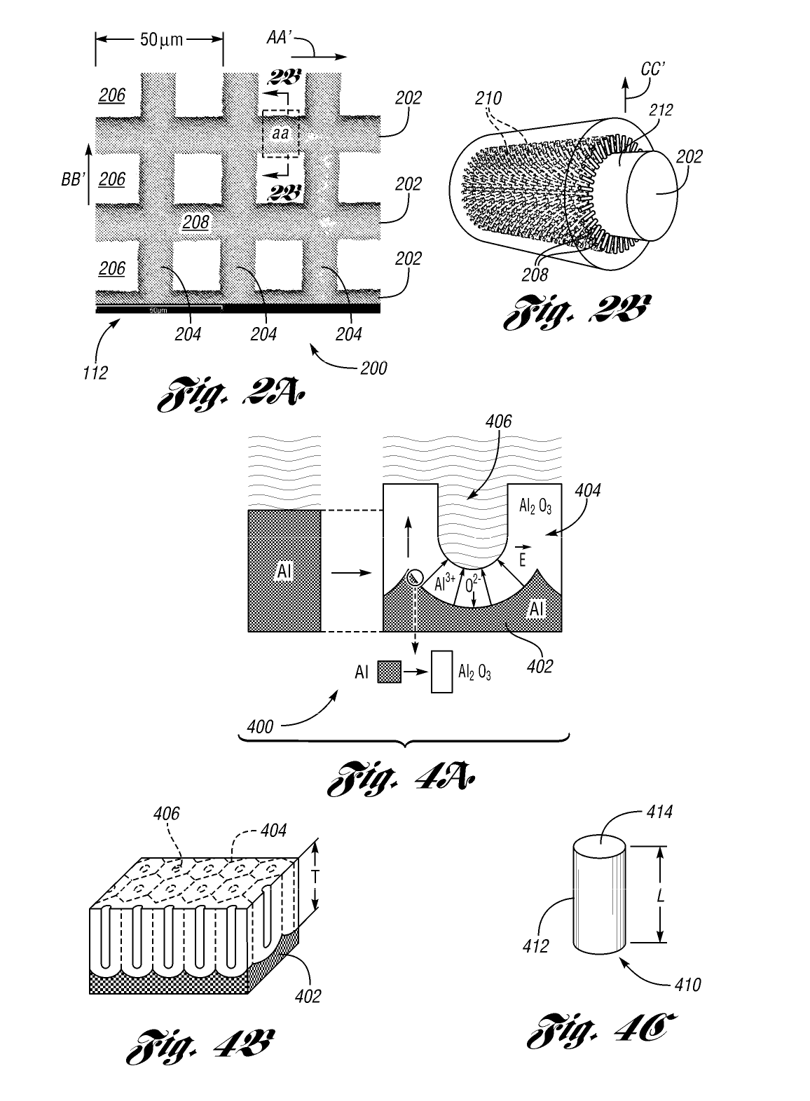

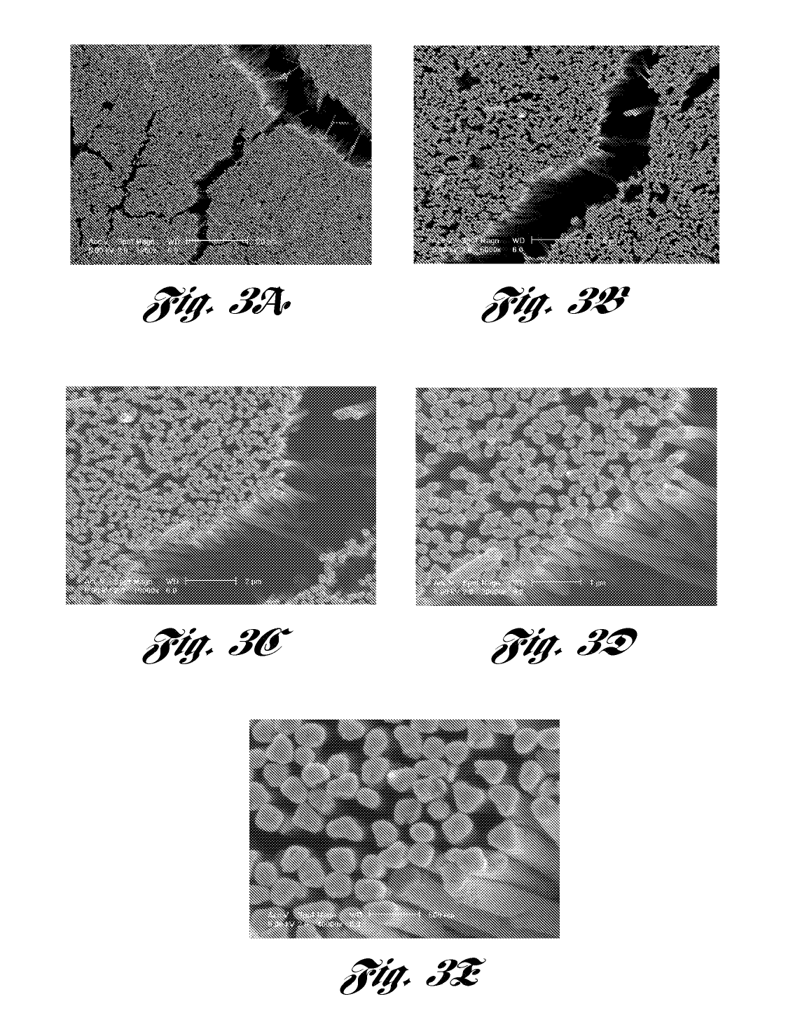

In this example, templates such as anodized alumina membrane (AAM) and radiation track-etched polycarbonate (PC) membranes are used. FIG. 3A depicts an enlarged top plan view of a plurality of wires grown using anodized alumina membrane (AAM). FIG. 3B depicts an enlarged view with 5,000× magnification of the wires of FIG. 3A. FIG. 3C depicts an enlarged top plan view of a plurality of wires grown using AAM membrane. FIG. 3D depicts an enlarged view with 20,000× magnification of the wires of FIG. 3C.

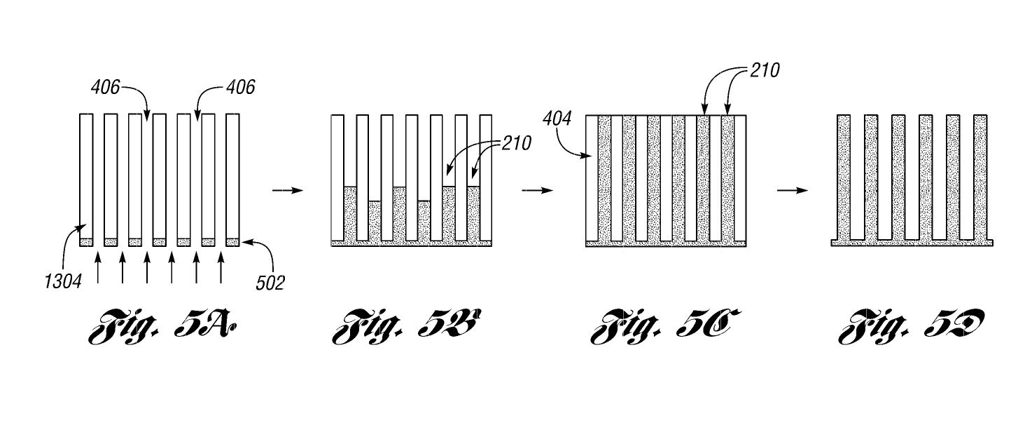

Commonly used alumina membranes having uniform and parallel pores are produced by the anodic oxidation of aluminum sheets or films in solutions of sulfuric, oxalic or phosphoric acid. As shown in FIGS. 4A-4B, the pores 406 can be arranged in a regular hexagonal array as seen in FIG. 4B, and as many as 10¹¹ pores/cm² can be obtained. Pore sizes range from 10 nm to 100 μm. After formation of the pores, the barrier oxide layer 402 at the bottom of the pores 406 is removed by dissolution in sodium hydroxide and mechanical agitation.

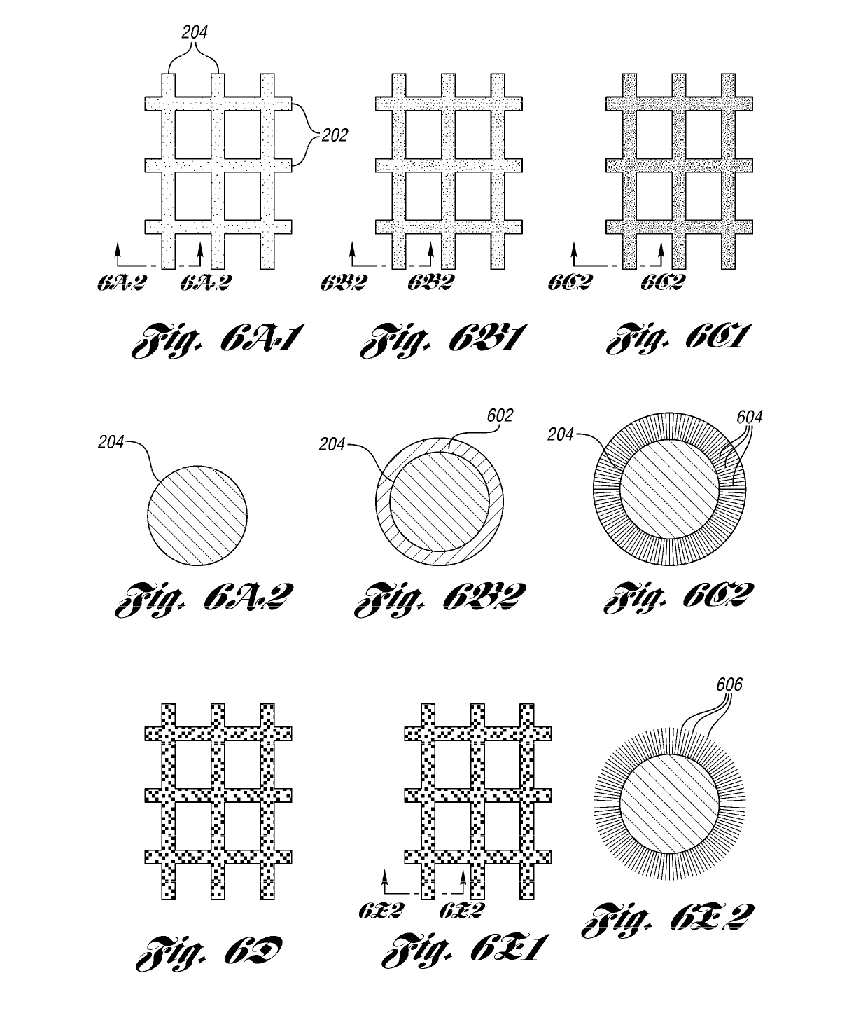

Wires 210 can be generated using electro-deposition follow thereafter according to FIGS. 5A-5D. As depicted in FIG. 5A, a conductive layer 502 of copper or gold is sputtered onto the bottom of the pores 406; as depicted in FIG. 5B, the wires 210 extend in length as electro-deposition continues; as depicted in FIG. 5C, the ends of the wires 210 are polished for desirable smoothness; and as depicted in FIG. 5D, the wires 210 are obtained by removing and etching the membrane 404 by the use of a base such as NaOH.

### Example 2

### Forming Wires on an Exemplary Interconnected Network Such as a Metallic Mesh

FIGS. 6A1-A2, B1-B2, C1-C2, 6D and 6E1-E2 collectively illustrate the steps taken to generate the wires 210 on an interconnected mesh substrate. FIG. 6A1 depicts an enlarged sectional view of the interconnected network of FIG. 2A. FIG. 6A2 depicts an enlarged cross-sectional view of one of the spaced apart strands 204 of FIG. 6A1 taken along line AA'. FIGS. 6B1-6B2 depict enlarged sectional view of the strand 204 having thereupon an aluminum film 602 as a base for forming a template for generating the wires. FIGS. 6C1-6C2 depict enlarged sectional view of the strand 204 having thereupon a plurality of pores 604 generated through anodization of the aluminum film 602. FIGS. 6D, 6E1 and 6E2 collectively depict an enlarged sectional view of the strand 204 having wires 606 formed thereupon.

### Example 3

### Evaluating Test Specifications of the Wires

Copper nanowires are grown in an electrochemical cell with templates made of Anodic Alumina Oxide (AAO), with pore diameters of 200 nm, 150 nm and 50 nm. Scanning Electron Microscope (SEM) images are shown in FIGS. 3A-3E for demonstration purposes.

A conventional catalyst provides a surface area of about 13-14 cm²/cm². A simple calculation based on the available size and wire number density according to the example described herein shows that it is feasible to match and surpass the conventional surface area of 13-14 cm²/cm². In fact, the thin film nanowire (TFNW) in one or more embodiments of the present invention can be configured to achieve a surface area of 50-70 cm²/cm².

Table I tabulates selected specifications of the wires grown according to the example. Some of the test specifications as referenced in Table I are defined according to the following. As depicted in FIGS. 4A-4B, a plurality of pores 406 are created within the AAO membrane 404, which is provided with an average thickness indicated as “T.” The average thickness “T” of the AAO membrane 404 as employed in this example is about 47-50 μm. A wire, generally shown at 410 in FIG. 4C, is grown to its length “L” within one of the pores 406. The length “L” of the wires 410 can be adjusted by controlling the extent of its growth; however, the length “L” should be no greater than the average thickness “T” for the AAO membrane 404. As referenced in the Table I, pore density is the number of pores 406 per square centimeters (cm²) of the AAO membrane 404. In this example, the growth of the wires 410 can be controlled such that the wires 410 have an average length of μm to 50 μm, and particularly 1 μm to 10 μm. As referenced in the Table I, peripheral area is the area shown at 412; basal area is the area shown at 414; and the total surface area represents the sum of the basal area and the peripheral area times the total number of the wires or the total number of the pores per cm², plus the void area on substrate where no wire is grown.

The calculations as shown in Table II, indicate that a metallic mesh substrate equipped with wires of 1 μm length can provide surface areas of about 10-57 cm²/cm² or more. This surface area can easily be increased by just increasing the length of the catalyst wires. The catalyst loading based on 4 layers of platinum on the metallic mesh substrate with wires comes down to 0.03 to 0.06 mg/cm².

TABLE I
Selected Specifications of the wires Grown

| | | AAO | | Total Surface |
|---|---|---|---|---|
| Pore | Pore | Membrane | Wire | Area |
| Density | Diameter | Thickness | Length | cm²/cm² growth |
| #/cm² | nm | μm | μm | surface |
| 2 × 10⁹ | 150 | 50 | 1.3 | 12.2 |
| 4 × 10⁹ | 73 | 47 | 1 | 9.2 |
| 5 × 10⁹ | 55 | 50 | 1 | 8.6 |
| 1 × 10¹⁰ | 35 | 49 | 1 | 11.0 |
| 1 × 10¹¹ | 13 | 50 | 1 | 40.8 |

TABLE IIA
Calculated Surface Area for Mesh Substrates of
Different Mesh Sizes having wires of 150 nm in diameter and
1.3 μm length of Table I

| Mesh Size | Total area | Pt loading |
|---|---|---|
| wires/inch | cm²/cm² mesh | g/cm² (×10⁻⁵) |
| 1500 | 18.1 | 6.07 |
| 1000 | 17.0 | 5.73 |
| 750 | 15.6 | 5.26 |
| 500 | 14.1 | 4.83 |
| 300 | 14.0 | 4.70 |

TABLE IIB
Calculated Surface Area for Mesh Substrates of
Different Mesh Sizes having wires of 55 nm in diameter and
1.0 μm length of Table I

| Mesh Size | Total area | Pt loading |
|---|---|---|
| wires/inch | cm²/cm² mesh | g/cm² (×10⁻⁵) |
| 1500 | 13.1 | 4.42 |
| 1000 | 12.4 | 4.17 |
| 750 | 11.4 | 3.83 |
| 500 | 10.4 | 3.51 |
| 300 | 10.2 | 3.42 |

TABLE IIC
Calculated Surface Area for Mesh Substrates of
Different Mesh Sizes having wires of 13 nm in diameter and
1.3 μm length of Table I

| Mesh Size | Total area | Pt loading |
|---|---|---|
| wires/inch | cm²/cm² mesh | g/cm² (×10⁻⁵) |
| 1500 | 73.7 | 24.8 |
| 1000 | 69.6 | 23.4 |
| 750 | 63.9 | 21.5 |
| 500 | 58.6 | 19.7 |
| 300 | 57.0 | 19.2 |

Compared among Tables IIA-IIC, at mesh size of 300 wires per inch for instance, wires having the smallest diameter of 13 nm collectively provide the largest total surface area of 57 cm²/cm². It is partly due to the fact that these thin wires of 13 nm are provided with a pore density of 1×10¹¹ which is higher than the pore density for the 150 nm wires referenced in Table IIA or the 55 nm wires referenced in Table IIB.

While the best mode for carrying out the invention has been described in detail, those familiar with the art to which this invention relates will recognize various alternative designs and embodiments for practicing the invention as defined by the following claims.

What is claimed:

1. A fuel cell catalyst layer comprising:
first spaced apart strands extending longitudinally in a first direction;
second spaced apart strands extending longitudinally in a second direction, the first and second spaced apart strands collectively defining openings bounded by an adjacent pair of the first spaced apart strands and an adjacent pair of the second spaced apart strands;
a number of wires formed on at least one of the first and second spaced apart strands; and
a catalyst contacting at least a portion of the number of wires.

2. The fuel cell catalyst layer of claim 1, wherein the catalyst further contacts at least a portion of the first and second spaced apart strands.

3. The fuel cell catalyst layer of claim 1, wherein the openings are provided with an average planar linear dimension of 10 to 70 micrometers.

4. The fuel cell catalyst layer of claim 1, wherein the openings are configured to contain a reagent selected from the group consisting of an ionomer, porous carbon, and combinations thereof to assist with water management and/or proton transport.

5. The fuel cell catalyst of claim 1, wherein the number of wires extend radially from a surface of at least one of the first and second spaced apart strands.

6. The fuel cell catalyst of claim 1, further comprising an intermediate material positioned between the catalyst and the portion of the wires.

7. The fuel cell catalyst of claim 1, wherein the catalyst includes a plurality of noble metal atoms disposed contiguously next to each other along at least one of the first and second directions.

8. The fuel cell catalyst of claim 7, wherein the catalyst includes a second plurality of noble metal atoms disposed contiguously next to each other along the third direction.

9. The fuel cell catalyst of claim 1, wherein the openings are configured to pass fuel cell reactants including water molecules, hydrogen molecules, oxygen molecules, and combinations thereof.

10. The fuel cell catalyst of claim 1, wherein at least a portion of the first and second spaced apart strands are in electronic and lattice communication with the catalyst.

11. The fuel cell catalyst of claim 7, wherein the catalyst is provided with 2 to 10 atomic layers of noble metal atoms in a thickness direction.

12. The fuel cell catalyst of claim 1, wherein the catalyst includes a metallic alloy of platinum and nickel.

13. The fuel cell catalyst layer of claim 1, further comprising an intermediate coating material disposed between the catalyst and at least a portion of the first spaced apart strands, the second spaced apart strands, and the number of wires.

14. The fuel cell catalyst layer of claim 1, further comprising a second layer of interconnected network formed of spaced apart strands, the second layer being disposed next to a first layer of interconnected network formed of the already existing first and second spaced apart strands.

15. A fuel cell electrode assembly comprising:
a substrate; and
a catalyst layer supported on the substrate, the catalyst layer configured to include first spaced apart strands extending longitudinally in a first direction, second spaced apart strands extending longitudinally in a second direction, the first and second spaced apart strands collectively defining openings bounded by an adjacent pair of the first spaced apart strands and an adjacent pair of the second spaced apart strands, the catalyst being provided with 2 to 10 atomic layers of noble metal atoms in a thickness direction.

16. The fuel cell electrode assembly of claim 15, further comprising a number of wires extending longitudinally in a third direction from at least a portion of the first and second spaced apart strands, and the catalyst contacting at least a portion of the plurality of wires.

17. The fuel cell catalyst assembly of claim 15, wherein the third direction of the plurality of wires is different from at least one of the first and second directions.

18. The fuel cell catalyst assembly of claim 15, wherein the substrate is one of a proton exchange membrane (PEM) or a gas diffusion layer (GDL).

19. The fuel cell catalyst assembly of claim 15, wherein the openings are configured to pass fuel cell reactants including water molecules, hydrogen molecules, oxygen molecules, and combinations thereof.

20. A fuel cell catalyst layer comprising:
an interconnected network of first spaced apart strands extending longitudinally in a first direction and second spaced apart strands extending longitudinally in a second direction, the interconnected network defining a number of openings bounded by an adjacent pair of the first spaced apart strands and an adjacent pair of the second spaced apart strands, the interconnected network further including a plurality of wires contacting at least one of the first and second spaced apart strands, the plurality of wires extending longitudinally in a third direction; and
a catalyst in overlaying contact with at least a portion of the first and the second spaced apart strands and at least a portion of the spaced apart wires;
wherein the third direction is different from at least one of the first and second directions;
wherein the catalyst includes a plurality of noble metal atoms disposed contiguously next to each other along at least one of the first and second directions;
wherein the openings are configured to pass fuel cell reactants including water molecules, hydrogen molecules, oxygen molecules, and combinations thereof.
